(19) United States
(12) Patent Application Publication
(10) Pub. No.: US 2026/0320092 A1
(43) Pub. Date: Oct. 15, 2026

(54) Multimodal Grounded Content Expansion

(71) Applicant: Adobe Inc., San Jose, CA (US)

(72) Inventors: Himanshu MAHESHWARI, Bengaluru (IN); Pranshu GAUR, Bokaro (IN); Danish JAVED, Kolkata (IN); Rishita EMANDI, Visakhapatnam (IN); Pritika RAMU, Bengaluru (IN); Aparna GARIMELLA, Bengaluru (IN)

(73) Assignee: Adobe Inc., San Jose, CA (US)

(21) Appl. No.: 19/175,920

(22) Filed: Apr. 10, 2025

(51) Int. Cl. G06F 16/3332; G06F 16/334; G06V 30/19

(52) U.S. Cl. CPC G06F 16/3334; G06F 16/334; G06V 30/19173

(57) ABSTRACT

A method of multimodal content generation includes receiving a request to generate a draft document. The request can include a text theme and one or more reference documents which include text content. Sentences can then be extracted from the text content and used, along with the text theme, to generate a text paragraph that is grounded in the sentences. A visual classifier can determine whether this generated text is visual text and, if so, image content can be retrieved or generated to be added to the draft document.

### BACKGROUND

Document editing often includes combining content from multiple sources. For example, one may start with a few points, such as an outline or bullet pointed list, and expand on each point by adding text, images, references, and other elements from one or more anchor documents, external websites, or other sources. Document creation has also taken advantage of the increasing availability of artificial intelligence-based tools. For example, large language models (LLMs) enable a first draft of a document to be created quickly from such an outline.

### SUMMARY

Introduced here are techniques/technologies for multimodal content expansion. A multimodal content generation system enables both text expansion and image expansion to be performed based on user provided content. For example, in text expansion a new paragraph of text is generated based on key sentences extracted from multiple reference documents and a user-entered text theme (e.g., brief description, bullet points, etc.). Text expansion may be performed by extracting relevant portions of the reference documents (e.g., paragraphs, sentences, etc.) and using these extracted sentences to ground the text expansion performed by a large language model (LLM). This reduces the likelihood of hallucination by the LLM and focuses the LLM to perform content generation using the reference documents rather than its own knowledge.

In addition to text expansion, embodiments also perform image expansion. In image expansion, the generated paragraph is used to obtain images from the reference documents and/or generate new images if the generated paragraph is identified as being visual-text. Through the use of multimodal models, such as CLIP, images from the reference documents that are relevant to the generated text can be identified and added to the generated draft. If no suitable image can be found, then a prompt can be generated based on the generated text and used to generate a new image.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of multimodal content generation, in accordance with one or more embodiments;

FIG. 2 illustrates an example of a text retrieval manager, in accordance with one or more embodiments;

FIG. 3 illustrates an example of a text expansion manager, in accordance with one or more embodiments;

FIG. 4 illustrates an example of a text visualization manager, in accordance with one or more embodiments;

FIG. 5 illustrates an example of an example user interface, in accordance with one or more embodiments;

FIG. 6-7 illustrates a process of creating a synthetic dataset, in accordance with one or more embodiments;

FIG. 8 illustrates an example of synthetic dataset curation, in accordance with one or more embodiments;

FIG. 9 illustrates a process of obtaining training data, in accordance with one or more embodiments;

FIG. 10 illustrates a schematic diagram of a multimodal content generation system in accordance with one or more embodiments;

FIG. 11 illustrates a flowchart of a series of acts in a method of multimodal content expansion, in accordance with one or more embodiments; and

FIG. 12 illustrates a block diagram of an exemplary computing device in accordance with one or more embodiments.

### DETAILED DESCRIPTION

One or more embodiments of the present disclosure include a multimodal content generation system that generates new content based on reference content and user input. Intelligent document editing that uses artificial intelligence-based technologies are gaining increasing attention due to the increased acceptance of generative models by users in creation, editing, and review workflows. In one conventional approach, large language models (LLMs) can be used to generate text content based on input text. Although this allows for the easy creation of new content, anchoring the LLMs output to some external document is difficult. For example, it is difficult or impossible to know whether the content generated by the LLMs is from the specified anchor documents or their own knowledge.

Conventional approaches attempt to solve the problem of hallucination by passing the entirety of a reference document to the LLM such that the generated content is based on the entire reference document. However, the content that can be passed to the LLM is limited by an LLM's inherent context limit. Because not all of the content can be processed by the LLM at once, the risk of hallucination by conventional techniques is increased. Unlike conventional approaches, the multimodal content generation system performs text expansion (e.g., also referred to as text content generation or text generation) using sentences extracted from reference documents to mitigate hallucination by the LLM. By using selected sentences, the content is generated based on the relevant portions of the reference documents without exceeding the context limit.

To address these and other deficiencies in conventional systems, embodiments enable multimodal content expansion in document editing based on external content sources. This enables users to create a document draft from scratch, where the user may provide a high-level outline or guidelines and then each section is generated based on the user-provided information and reference documents. The user-provided information can be simple points, key phrases, etc. In some embodiments, the user-provided information can include meta-level guidelines which are iteratively updated to be more fine-grained. This content generation is multimodal, such that the generated content may include text as well as visual content. Additionally, embodiments enable intelligent document editing based on user intent. For example, the user can add content (e.g., text or images) related to specific concepts and the multimodal content generation system then generates additional related content based on the newly added content and reference documents.

In addition to expanding text content, the multimodal content generation system can also predict if the expansion can be aided via visual illustration. If so, embodiments generate prompts automatically to query image-text models based on the provided and/or generated text content. Further, embodiments do not require any labelled data for these tasks. Instead, heuristics are used to synthetically curate datasets from one specific domain.

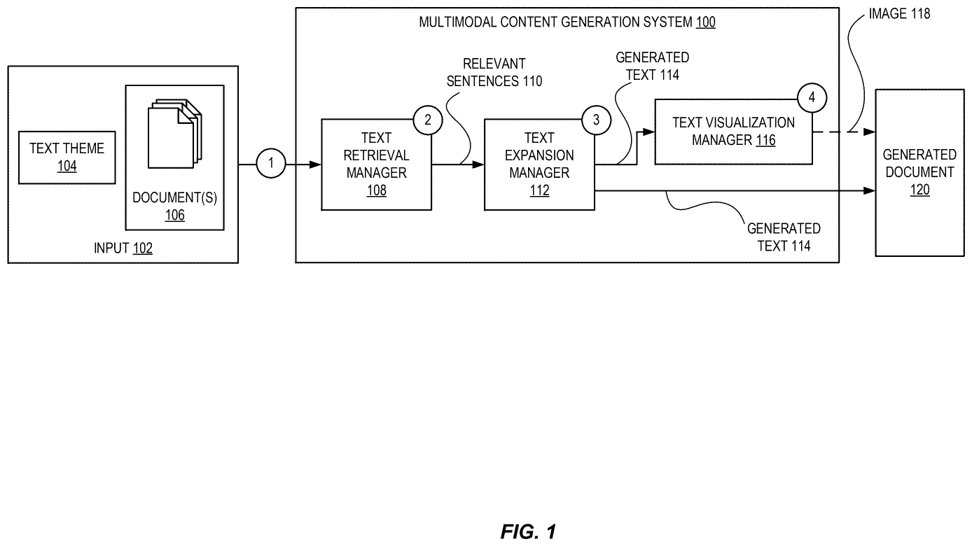

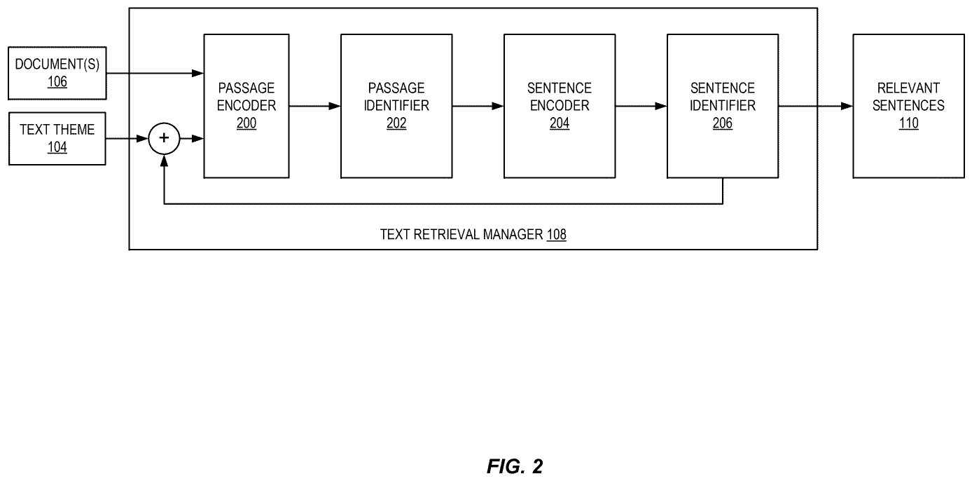

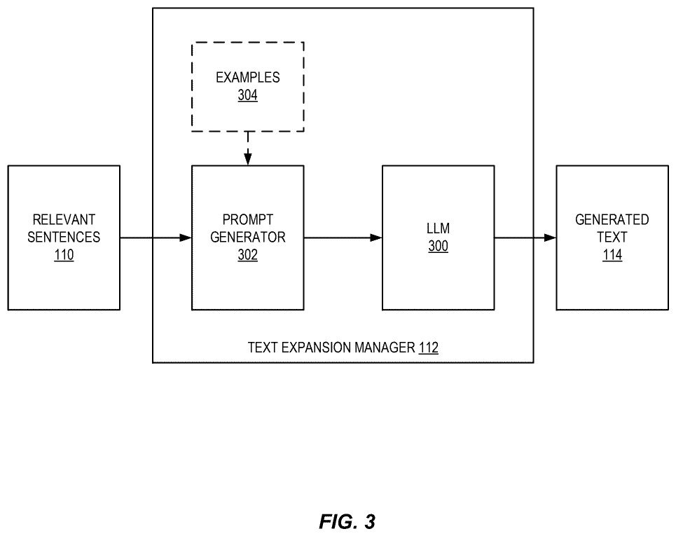

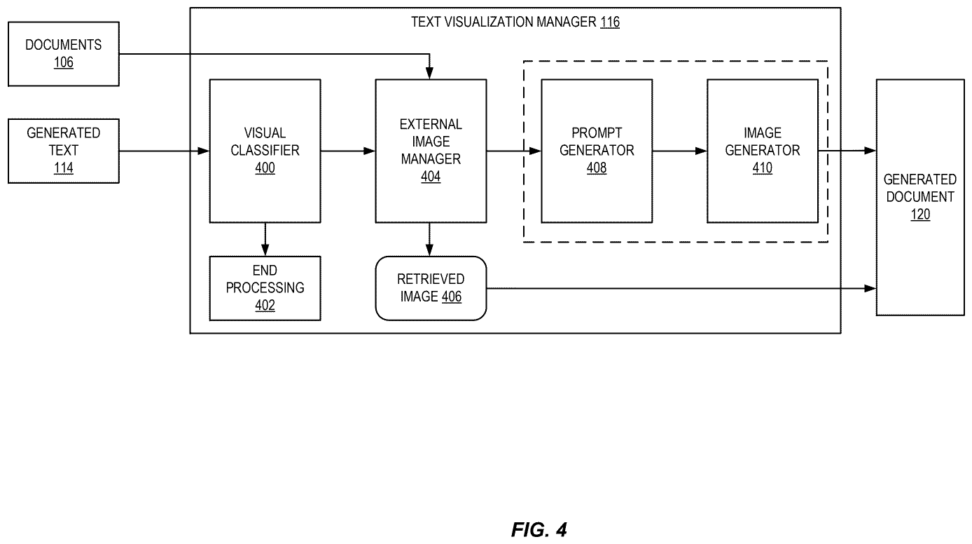

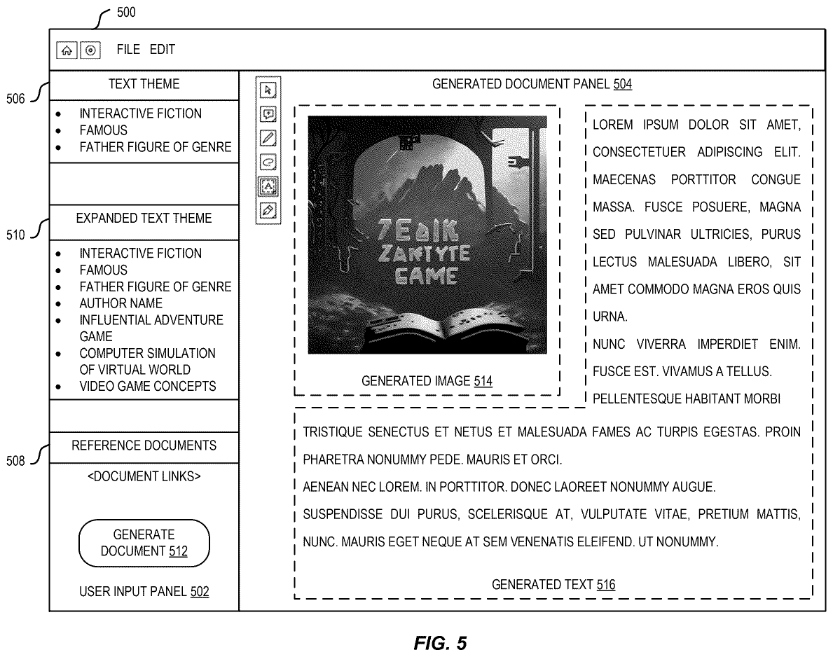

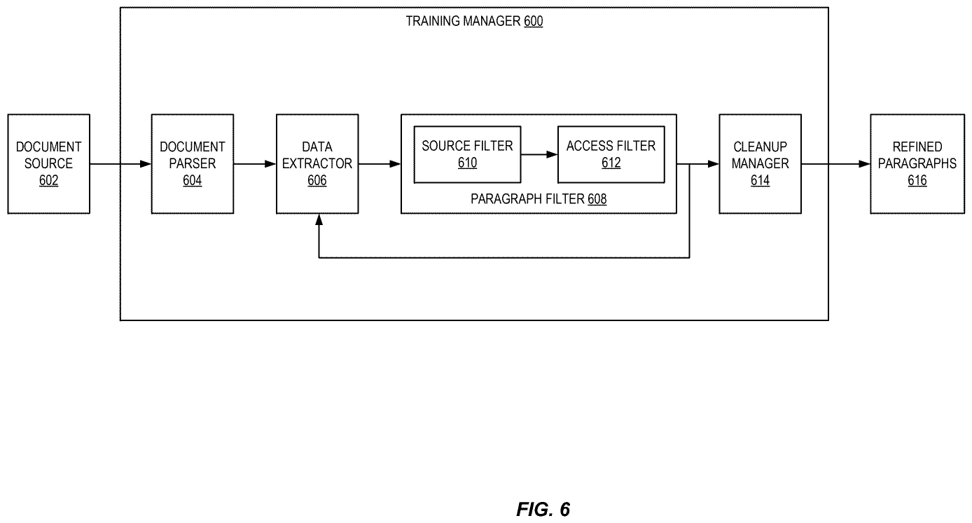

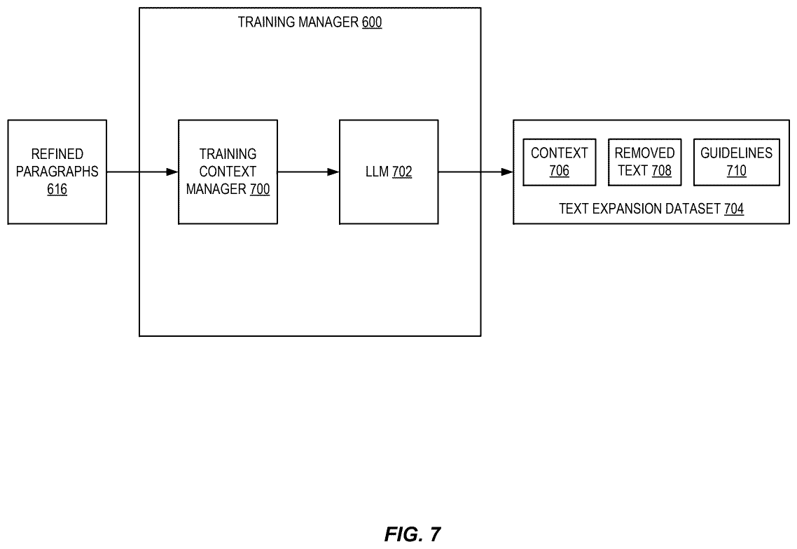

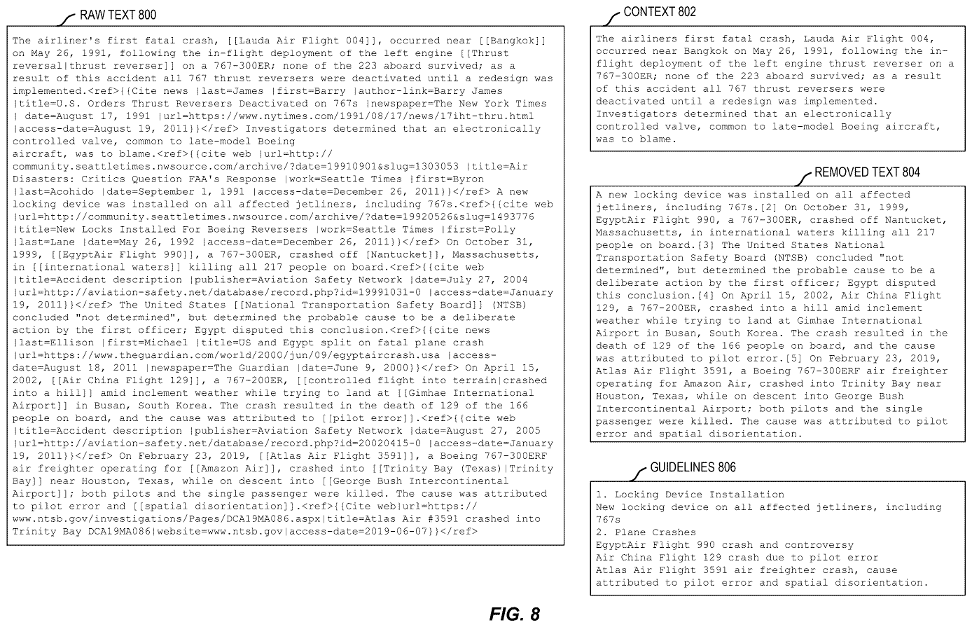

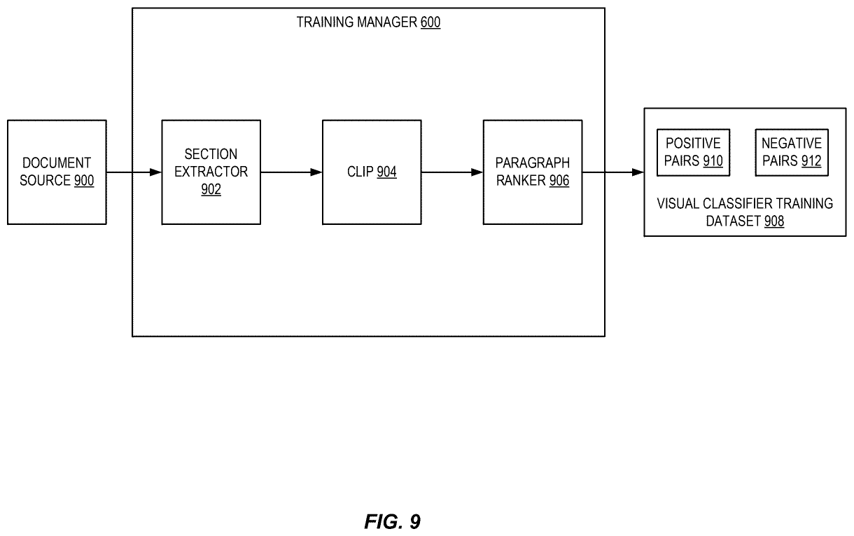

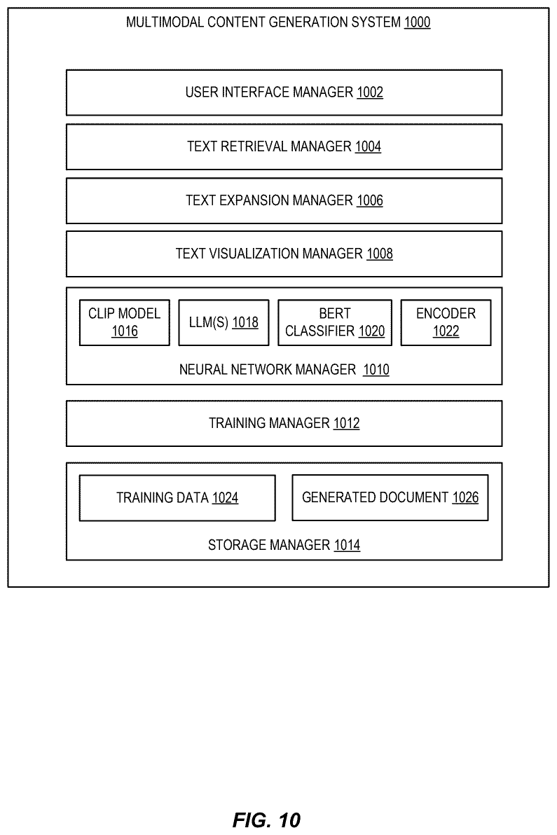

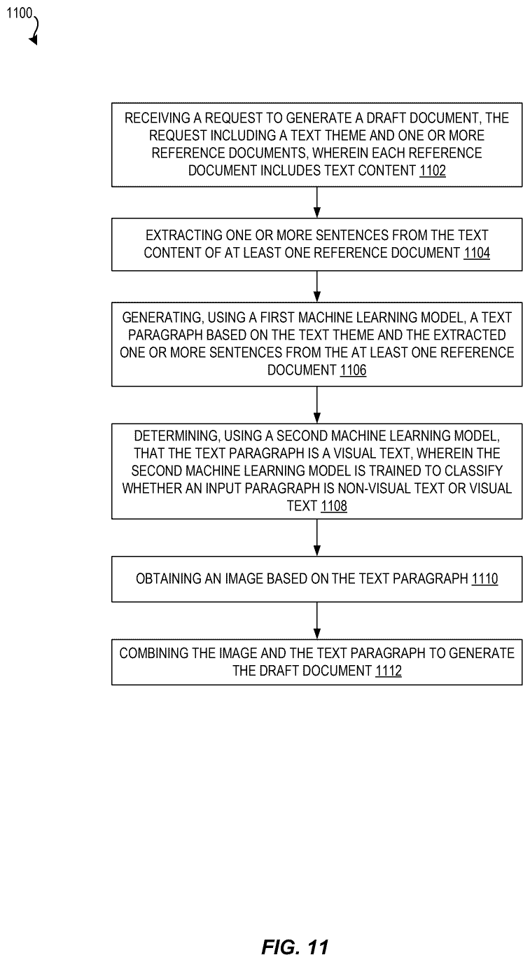

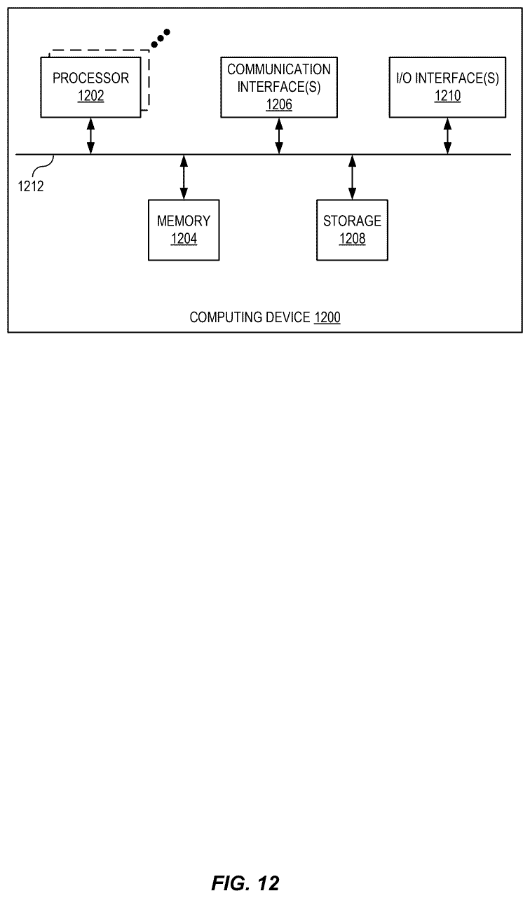

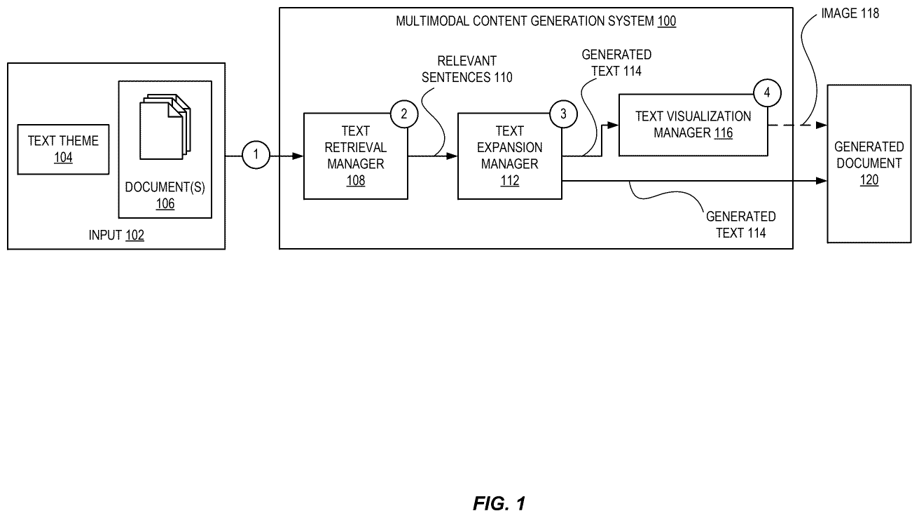

FIG. 1 illustrates a diagram of a process of multimodal content generation, in accordance with one or more embodiments. As shown in FIG. 1, embodiments include a multimodal content generation system 100. Multimodal content generation system 100 may be implemented, for example, as a standalone service or within a larger application or suite of applications. For example, the multimodal content generation system 100 may be implemented as part of a document reader application, document editing application, etc.

At numeral 1, the multimodal content generation system 100 receives input 102. Input 102 may include a text theme 104 and one or more documents 106. In some embodiments, the text theme may be a short text description, such as an outline, bullet points, etc. describing a user intent (e.g., a theme) of the document being drafted. The documents 106 can include any digital file including one or more paragraphs or collections of text. For example, the input 102 may be digital text such as a document, a book, a poster, a website, and the like. In some embodiments, the input 102 includes digital files with the following, or other file extensions: . DOC, .DOCX, .PDF, .TXT, .HTML, .RTF, or .ODT. In some embodiments, the input 102 may be provided to the multimodal content generation system 100 via a user interface, when the user selects an icon, tool, or other user interface element within, e.g., the document editing application associated with the multimodal content generation system 100. The input 102 may be uploaded to the multimodal content generation system 100, downloaded from a remote location (e.g., via a link to a network storage location), selected from a local file system, etc.

At numeral 2, the text retrieval manager 108 extracts text from the documents 106. For example, input 102 may be a document including one or more pages, where each page includes sentences and paragraphs. The text retrieval manager 108 can first retrieve portions of text from the documents that are relevant to the theme and then segment each portion into smaller portions. For example, the text retrieval manager 108 may segment the documents into paragraphs and identify relevant paragraphs to the theme. The relevant paragraphs can then be further segmented into sentences and relevant sentences are then identified. In some embodiments, use of paragraphs provides adequate context during retrieval and sentence-level granularity avoids noise or irrelevant context from the other parts of the paragraphs.

The text retrieval manager 108 can segment the text of the document into one or more pages, one or more paragraphs, one or more sentences, one or more phrases, one or more words, and the like. In some embodiments, a user may configure the granularity of the segmented text. For example, a user may configure a page of text included in input 102 to be segmented into paragraphs, sentences, and/or words. In some embodiments, the input 102 is pre-segmented. That is, the input 102 is received at numeral 2 in sentences, paragraphs, words, etc.

In some embodiments, the text retrieval manager 108 encodes the paragraphs from the documents and the theme using a sentence transformer (e.g., all-mpnet-base-v2). The top k paragraphs can then be retrieved based on the cosine similarity (or other similarity metric) between the encoded representations (e.g., embeddings) of the paragraphs and the theme. Since the number of paragraphs in the external documents can be very large, embodiments may use approximate nearest-neighbor searches to optimize search time. In some embodiments, ScaNN is used to search relevant paragraphs for each user's intent, however various approximate nearest-neighbor search algorithm may be used.

The text retrieval manager 108 outputs relevant sentences 110. As discussed, the portions output by the text retrieval manager 108 may be larger or smaller portions of text. The relevant sentences 110 are provided to text expansion manager 112. At numeral 3, the text expansion manager 112 uses the relevant sentences 110 to generate new text 114. For example, the input to the text expansion manager 112 includes the retrieved sentences from the text retrieval manager 108, and the output is a coherent, fluent, and grounded paragraph of generated text 114. This paragraph forms the textual part of the content expansion. In some embodiments, the text expansion manager 112 includes an LLM, such as GPT-3.5 turbo or other LLM, to perform retrieval augmented generation.

As shown in FIG. 1, the generated text 114 can be added to the generated document 120 and also provided to text visualization manager 116. At numeral 4, text visualization manager 116 can predict whether the generated text is visual (e.g., if the text can be better represented using image content in addition to the text content). In some embodiments, a classifier predicts whether the generated text 114 is visual. If the text is predicted to be non-visual, then no images are retrieved or generated. If, however, the text is predicted to be visual, then image content 118 is retrieved or generated and added to the generated document 120. In some embodiments, the image content 118 is retrieved from the reference documents 106. Additionally, or alternatively, if no related image content is included in the reference documents, then image content 118 can be generated using, e.g., a text to image model.

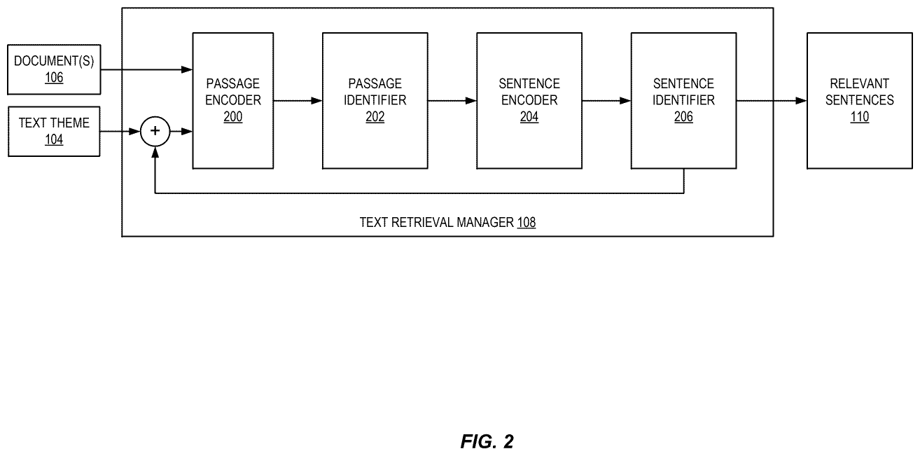

FIG. 2 illustrates an example of a text retrieval manager, in accordance with one or more embodiments. As shown in FIG. 2, the text retrieval manager 108 receives the reference documents 106 and text theme 104. As discussed, the text theme describes a user intent, which can be represented through key phrases, bullet points, etc. The output includes one or more relevant sentences 110 from the reference documents 106 to the text theme 104. These sentences are then used for generating textual content.

As shown in FIG. 2, the document(s) 106 and text theme 104 are both received by a passage encoder 200. The passage encoder 200 may be a sentence transformer (e.g., such as all-mpnet-base-v2 or other sentence encoder) which generates a representation of portions of text from the document(s) and a representation of the text. In some embodiments, the passage encoder may generate an embedding (e.g., a vector in a high dimension vector space) which represents a portion of text. For example, the portion of text may be a paragraph. In such instances, each paragraph of the document(s) is passed to the passage encoder which generates a corresponding representation (e.g., embedding). Although embodiments are generally described with respect to encoding paragraphs, in various embodiments other more or less granular portions of text may alternatively be encoded, depending on implementation.

Once the paragraphs have all been encoded, along with the text theme, passage identifier 202 can identify the paragraphs that are most similar to the text theme. For example, in some embodiments, the passage identifier 202 can compare the representations of the paragraphs to the representation of the text theme and identify the top k paragraphs based on cosine similarity (or other similarity metric). Since the number of paragraphs in the external documents can be very large, approximate nearest-neighbor searches may be used to optimize search time. In some instances, ScaNN may be used to search for relevant paragraphs for the user's intent though other approximate nearest-neighbor search algorithms may alternatively be used.

Once the relevant paragraphs have been identified, the next task is to identify the top sentences from these paragraphs pertinent to the user's text theme. In the example of FIG. 2, the relevant paragraphs may be passed to sentence encoder 204 which encodes each sentence from each paragraph. For example, the sentence encoder may be a sentence transformer. This may be the same sentence transformer as used by passage encoder 200 or a different sentence encoder. The sentence encoder outputs representations (e.g., sentence embeddings), where one sentence embedding corresponds to each input sentence from the input relevant paragraph(s). Sentence identifier 206 can then identify relevant sentences 110 by comparing the encoded representations of the sentences to the encoded representation of the text theme. Similar to the passage identifier discussed above, in some embodiments, the sentence identifier can identify the top k sentences based on cosine similarity (or other similarity metric).

The retrieval performs poorly if the text theme is sparse or vague. To make the user guidelines more concrete, embodiments retrieve key phrases from the retrieved sentences and use them to expand the original user intent. For example, these key phrases may be passed back to the passage encoder and combined with the original text theme (e.g., concatenated or otherwise combined). This new text theme can then be encoded by the passage encoder and used for retrieval. This process can be repeated multiple times (e.g., three to five times was often found sufficient) to develop stronger text themes. The retrieved sentences after the last iteration are then output as relevant sentences 110.

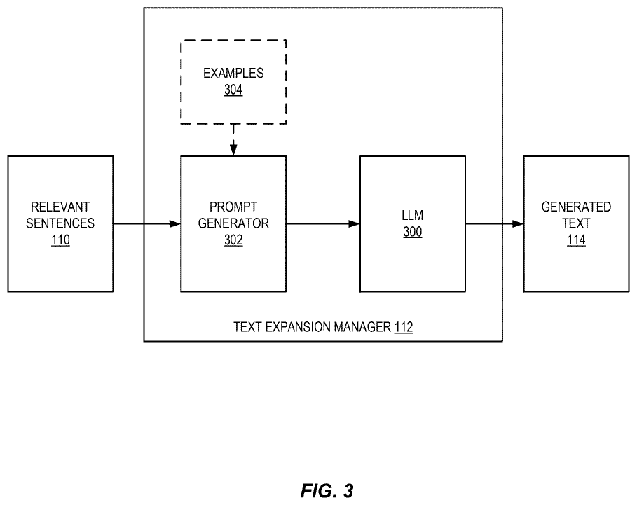

FIG. 3 illustrates an example of a text expansion manager, in accordance with one or more embodiments. The input to the text expansion manager 112 includes the retrieved sentences 110, and the output is a coherent, fluent, and grounded paragraph. This paragraph forms the textual part of our content expansion. This technique of generating text using retrieval is called retrieval augmented generation.

As shown in FIG. 3, the relevant sentences 110 are provided to text expansion manager 112. The text expansion manager 112 can include an LLM 300, such as GPT-3.5 turbo, or other LLM. How the LLM is prompted can affect the quality of the output. For this task, it is desired that the LLM outputs are grounded on the relevant sentences and should not use the LLM's internal knowledge. Additionally, the relevant sentences should flow coherently and fluently into one paragraph. Also, each sentence in the output paragraph should be attributable to some input sentence. In some embodiments, a combination of prompting techniques can be used to ensure that the above qualities are met. For example, prompt generator 302 can provide detailed step-by-step instructions to the LLM 300 on how to generate the output using the relevant sentences 110. This technique of giving step-by-step instructions to an LLM is called chain-of-thought prompting. Additionally, in some embodiments, the LLM can be provided prompt/generation examples 304 to learn from. This idea of giving a few examples is called the few-shot prompting and has been shown to help the LLM produce better outputs.

The prompt generator 302 can combine the relevant sentences with the step-by-step generation instructions and, optionally, the prompt/generation examples 304 into a single prompt. This prompt is then provided to LLM 300 which generates generated text 114.

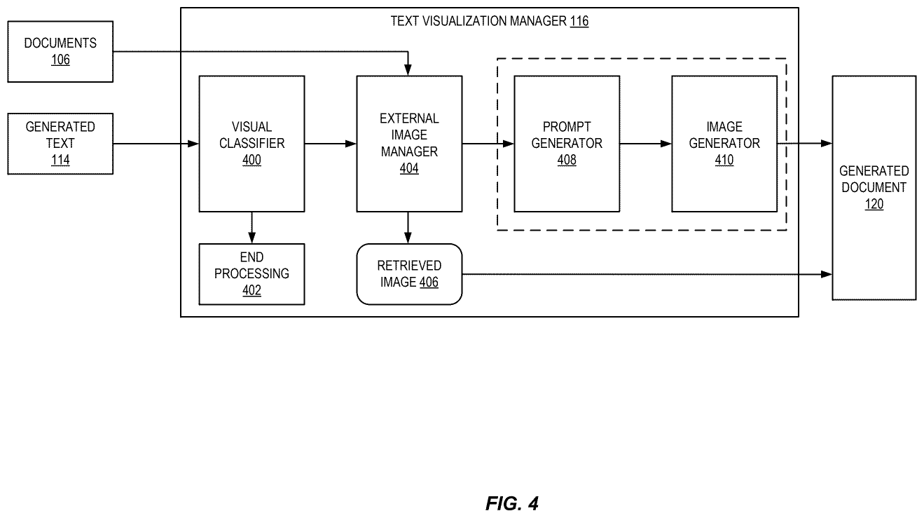

FIG. 4 illustrates an example of a text visualization manager, in accordance with one or more embodiments. The input to the text visualization manager 116 includes the generated text 114. The text visualization manager116 then predicts if this text content is visual text content (e.g., if images would provide better representation and visualization).

As shown in FIG. 4, the generated text 114 is provided to visual classifier 400. In some embodiments, visual classifier 400 can be implemented as a BERT classifier to predict textual visualness. In some embodiments, the BERT classifier may be fine-tuned as discussed further below. Alternatively, a few-shot chain of thought-prompted LLM may be used to predict visualness, however in practice the BERT classifier was found to be more accurate. If the visual classifier determines the generated text 114 does not need images, the processing ends at 402 and no image content is added to the generated document 120.

However, if the visual classifier 400 determines that the generated text 114 is visual, then the external image manager 404 can begin the process of obtaining image content for the generated document. The reference documents 106 may include images. If so, and if these images are relevant to the generated text, then they may be retrieved from the documents 106.

In some embodiments, external image manager 404 can include a contrastive learning image pretraining (CLIP) model, or other multimodal modal, which generates embeddings for the images in documents 106 and the generated text 114. The external image manager 404 can use the cosine similarity of the CLIP embeddings to determine the relevance of the corresponding images to the generated text. External images with a cosine similarity greater than a threshold are considered relevant. In some embodiments, a threshold of 0.34 was found to produce adequate results. The relevant images can be retrieved from the documents 106, and the retrieved images 406 can be added to the generated document 120. In some embodiments, if there are relevant images, the top relevant image per paragraph is retrieved and presented, along with textual content, to the user as the final expansion. If there are no relevant images, then images are generated.

As shown in FIG. 4, if no relevant images are found, then prompt generator 408 and image generator 410 are invoked. The input to the prompt generator 408 is the expanded text, and the output of the image generator 410 is a generated image. In some embodiments, the prompt generator may include a key-phrase extraction model which identifies key themes in the generated text. In some implementations, noun phrases can be removed from these key themes as the quality of images having noun phrases was found to be unsatisfactory. The prompt generator then combines the key themes into a one sentence prompt using an LLM. The prompt is then provided to image generator 410. The image generator can include a diffusion model to generate images. Once the image is generated, it is added to the generated document 120 and presented to the user.

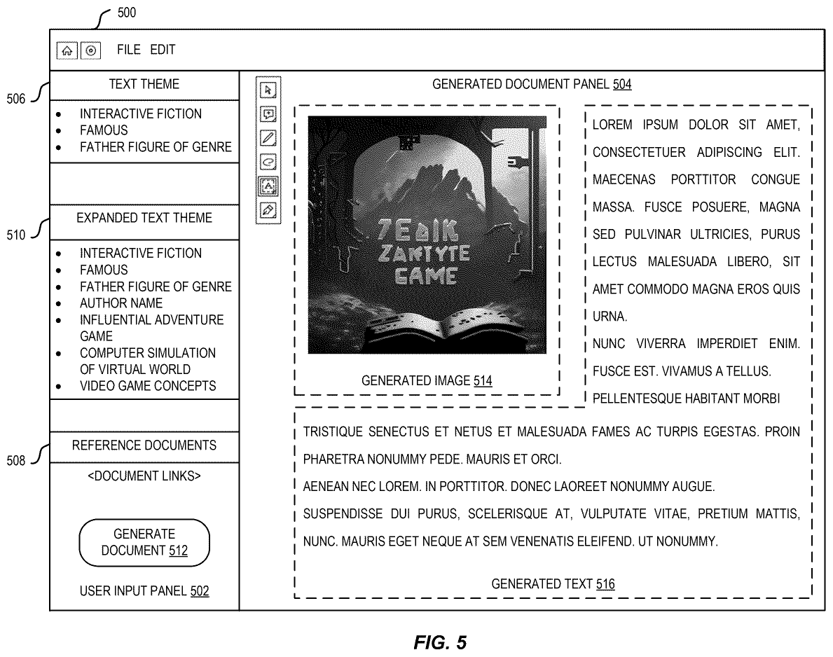

FIG. 5 illustrates an example of an example user interface, in accordance with one or more embodiments. As shown in FIG. 5, an example user interface 500 includes a user input panel 502 and generated document panel 504. In this example, the user input panel 502 is a side panel. However, in various embodiments, the user interface may obtain user input via a pop-up window, floating panel, or other user interface element. As shown, the user can enter a text theme 506 and provide reference documents 508. In this example, the text theme can be entered directly in the panel and reference document links are added. Alternative implementations may obtain this input in various ways. As discussed, during content generation, the text theme may be automatically expanded by the multimodal content generation system. In some embodiments, the expanded text theme 510 can also be presented to the user via the user input panel. Alternatively, the expanded text theme may be presented via a different user interface element or may not be presented to the user at all. By presenting the expanded text theme to the user, the user is given the opportunity to edit the text theme further, as desired.

In some embodiments, the user can request a document be generated by selecting a user interface element, such as generate document button 512. Once selected, the techniques described herein can be used to generate a document, as discussed. The resulting generated document can be presented to the user in generated document panel 504. As shown, the generated document can include a generated image 514 and generated text 516. As discussed, the image content included in then generated document can include generated images or images retrieved from the reference documents.

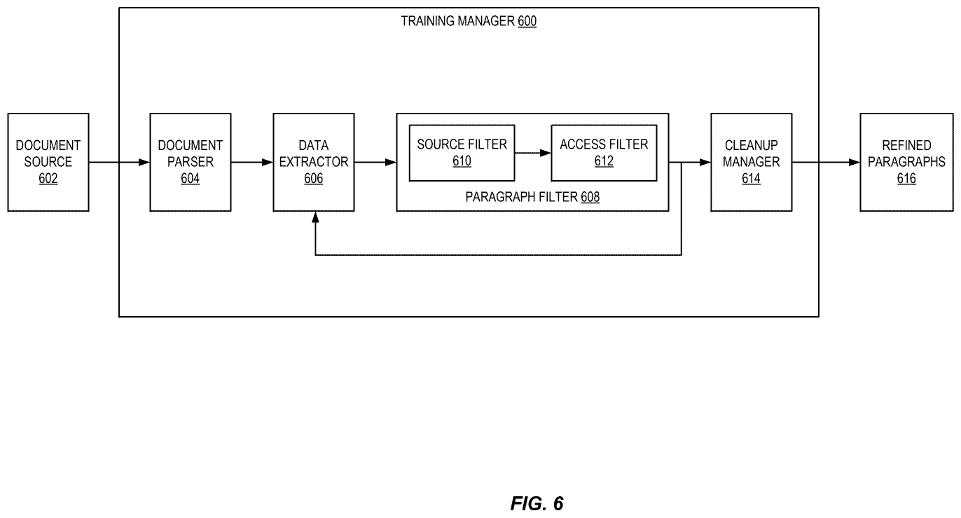

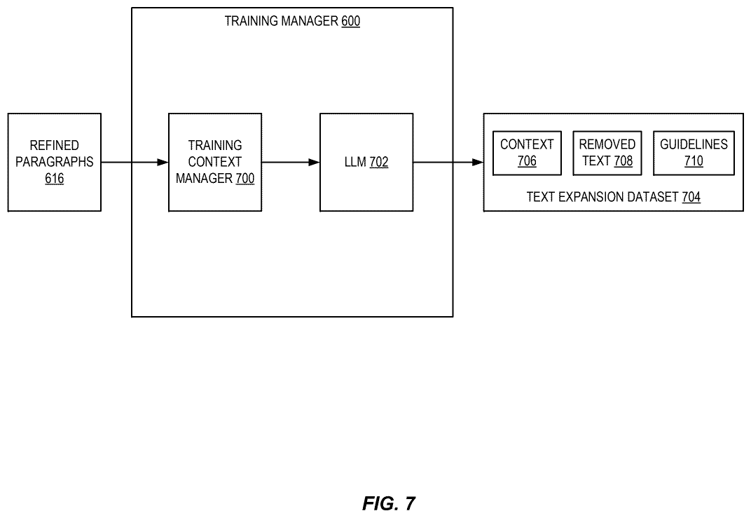

FIG. 6-7 illustrates a process of creating a synthetic dataset, in accordance with one or more embodiments. As shown in FIG. 6, a training manager can receive documents from a document source 602. The document source can include any public or private corpus of information, such as the publicly available Wikipedia corpus, a private corporate or academic data source, or other document source. Raw data is acquired by parsing the document source 602 using a document parser 604 to obtain the raw text files. A data extractor 606 can then extract relevant information from the raw text data. For example, the data extractor 606 may extract document name, section heading(s), paragraph content, the corresponding references embedded within each paragraph, etc. In some embodiments, a paragraph filter 608 may be employed to selectively retain only paragraphs associated with “good references” to maintain data integrity. For example, the paragraph filter can include a source filter 610 which may use expression-based filtering mechanism to identify and exclude undesirable references, which may include links to social media platforms, specific file formats, and unverifiable sources. An example of such a source filter may include: Bad Reference Regex Filter: {“doi”, “isbn”, “facebook”, “books. google”, “DOI”, “ISBN”, “cite book”, “cite journal”, “. pdf”, “. mp3”, “. mp4”, “download”, “.xlsx”, “.ppt”, “.csv”, “.png”, “.jpg”, “.jpeg”, “.svg”}.

Additionally, an accessibility filter 612 can be used to ensure the reliability of the dataset being created. The accessibility filter 612 can check the accessibility of each reference URL. Primarily, this involves conducting checks to identify 404 errors or other accessibility issues (e.g., where the reference no longer exists or cannot otherwise be accessed). In some embodiments, references that pass the accessibility check are further processed to extract their textual content. This content is subsequently tagged with a unique identifier to facilitate future attribution and traceability. Embodiments can apply additional filtering criteria, to eliminate references where the text extracted from the corresponding website is devoid of content or lacks substantive information. For example, a cosine similarity metric can be used in such a filter. For example, in cases where no paragraph from a reference website exhibits a similarity score exceeding a threshold of 0.2, the reference is rejected, ensuring that references that have some topical similarities are included in the dataset. Alternative threshold values may be used depending on implementation.

Once the data from the document source 602 has been processed, cleanup manager 614 is responsible for cleaning the paragraphs to remove any extraneous elements that were obtained from the raw text, resulting in refined paragraphs 616. The cleanup manager 614 can also include working reference attributions to ensure proper citation and provenance tracking within the dataset.

As shown in FIG. 7, the refined paragraphs 616 can then be provided to training context manager 700. The training context manager 700 can split the refined paragraphs to create an initial context and removed text. For example, the first two sentences of a paragraph can be taken as the initial context. This is then used to prompt LLM 702 to generate coarse and fine guidelines to automatically create user guidelines (e.g., text themes) for the removed text. Additionally, for the guidelines generated if the given set of references are not sufficient, then additional reference URLs can be retrieved using a search API to find additional sources on the Internet or other accessible data sources. The resulting text expansion dataset 704 used to train the text expansion manager 112 includes the context data 706 (e.g., the first two sentences of each refined paragraph), the removed text 708 (e.g., the remaining content from each paragraph), and the guidelines 710 (e.g., the generated text themes for the removed text from each paragraph).

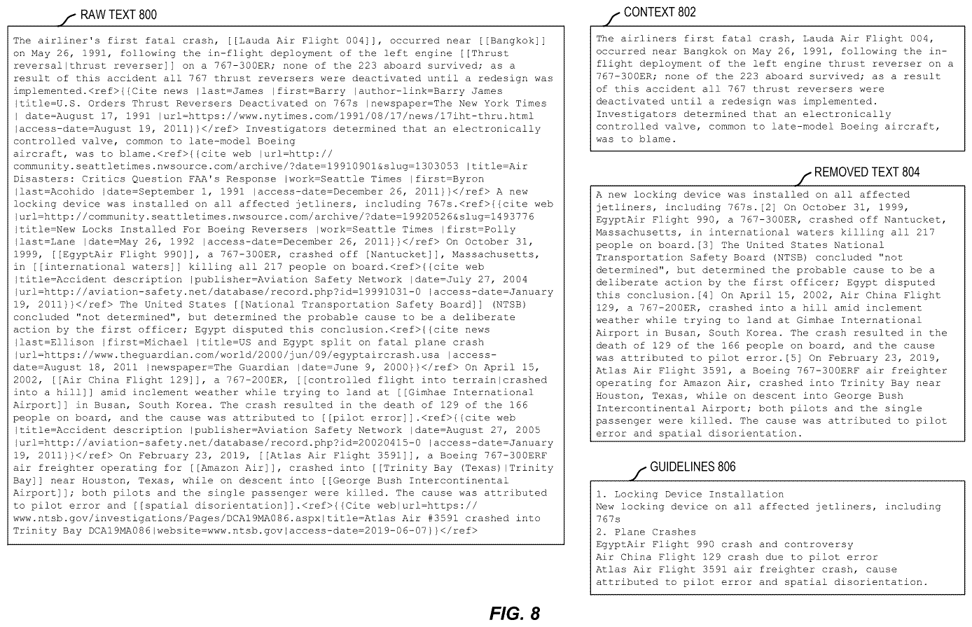

FIG. 8 illustrates an example of synthetic dataset curation, in accordance with one or more embodiments. An example of the synthetic dataset is shown in FIG. 8. As shown in FIG. 8, raw text 800 can include the extracted text from a document from a document source. This includes formatting, URL links, etc. After processing the raw text 800, as discussed above, a context 802 is obtained corresponding to the first two sentences of the processed content and removed text 804 corresponding to the remaining text. Additionally, the guidelines 806 are generated based on the removed text 804.

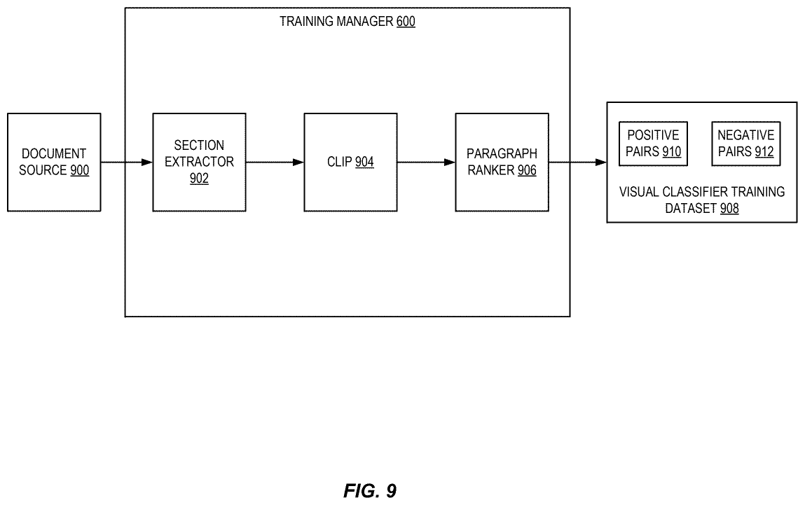

FIG. 9 illustrates a process of obtaining training data, in accordance with one or more embodiments. As shown in FIG. 9, a dataset can be curated for training the visual classifier 400, discussed above. For example, in some embodiments, the visual classifier 400 is a BERT classifier. The BERT classifier can be fine tuned using this training dataset. Documents from a document source,

As shown in FIG. 9, a training manager 600 can receive documents from a document source 900. The document source 900 can include any public or private corpus of information, such as the publicly available Wikipedia corpus, a private corporate or academic data source, or other document source. A section extractor 902 can identify and extract portions of text (e.g., sections) from each document along with any image content. Within a given section, multiple paragraphs may exist, but not all are accompanied by images. The association between paragraphs and images can be determined using CLIP model 904. CLIP model 904 can generate an embedding for each image and sentence extracted from the documents. These embeddings can then be used by paragraph ranker 906 to assess the maximum CLIP embedding score between each sentence within a paragraph and the associated image. The CLIP embedding score is a measure of semantic similarity and helps identify the textual relevance of a paragraph to an image. The paragraphs are subsequently ranked based on their CLIP score in relation to the associated image within the section. This ranking is used in prioritizing the selection of paragraphs with the highest textual relevance and least textual relevance to the image. To ensure the inclusion of visually relevant paragraphs, embodiments employ a threshold-based selection approach. Specifically, embodiments retain the top k % and bottom k % of the ranked paragraphs, where k % is determined by preset thresholds. In some implementations, the thresholds of 0.308 and 0.262 were determined to perform adequately to ascertain the top k % and bottom k %, respectively.

The top k % of paragraphs are considered to be visually significant, as they exhibit a strong textual connection with the associated image. The bottom k % of paragraphs are categorized as non-visual, as they demonstrate a weaker textual correlation with the image. Using this approach, visual classifier training dataset 908 can be curated to include positive pairs 910 and negative pairs 912, which can then be used to train the visual classifier (e.g., BERT model) for text visualness prediction.

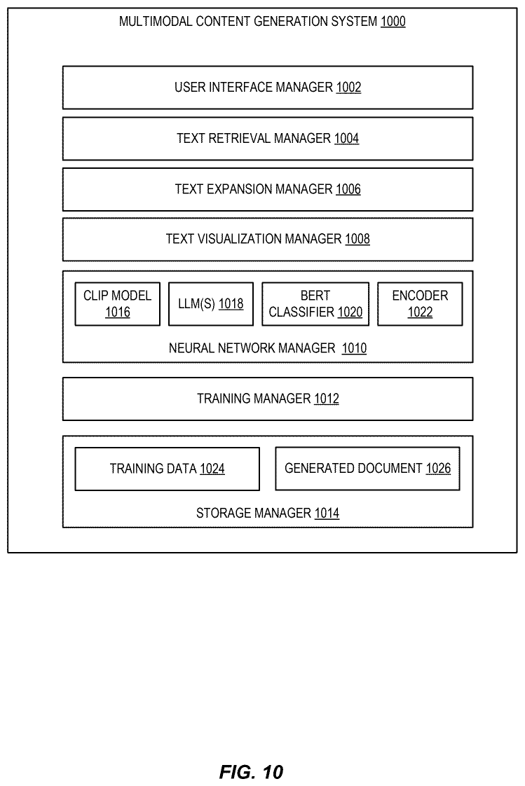

FIG. 10 illustrates a schematic diagram of a multimodal content generation system (e.g., “multimodal content generation system” described above) in accordance with one or more embodiments. As shown, the multimodal content generation system 1000 may include, but is not limited to, a user interface manager 1002, a text retrieval manager 1004, a text expansion manager 1006, a text visualization manager 1008, a neural network manager 1010, a training manager 1012, and a storage manager 1014. The neural network manager 1010 includes various machine learning models as discussed herein, such as CLIP model 1016, LLMs 1018, BERT classifier 1020 and encoder 1022. The storage manager 1014 includes training data 1024 and generated document 1026.

As illustrated in FIG. 10, the multimodal content generation system 1000 includes a user interface manager 1002. For example, the user interface manager 1002 allows users to provide input text data and reference documents to the multimodal content generation system 1000. In some embodiments, the user interface manager 1002 provides a user interface through which the user can upload the input text (e.g., the text theme), which represents the user intent of the content to be expanded with generated text and images, as discussed. Additionally, the user interface manager 1002 allows users to view the generated document 1026. In some embodiments, the user interface manager 1002 allows the user to view and/or edit the expanded text theme and regenerate the document. Additionally, or alternatively, the user interface manager 1002 can present retrieved and/or generated images to be added to the generated document. This allows the user to select the image he or she views as most relevant to the generated document.

As illustrated in FIG. 10, the multimodal content generation system 1000 includes a text retrieval manager 1004. As discussed, the text retrieval manager 1004 can parse the input documents into separate portions (e.g., sections, paragraphs, etc.) and identify portions that are relevant to the text theme. In some embodiments, the text retrieval manager includes a passage encoder which generates an embedding corresponding to each input paragraph from the reference documents and an embedding for the text theme. By comparing these embeddings, e.g., using an approximate nearest neighbors algorithm, the most similar paragraphs to the text theme. The most similar paragraphs can then be further parsed into individual sentences and similarly processed using a sentence encoder to identify the sentences most similar to the text theme. As discussed, in some embodiments, the passage encoder and the sentence encoder can be the same encoder, such as encoder 1022. In some embodiments, key phrases from the relevant sentences can be used to augment the text theme and the text retrieval manager then iteratively processes the documents (e.g., a set number of iterations, or other end condition) to identify the relevant sentences from the documents to the text theme.

The multimodal content generation system 1000 also includes text expansion manager 1006. The text expansion manager 1006, as discussed, receives the relevant sentences from the text retrieval manager and generates new text content grounded in the relevant sentences. As discussed above, the text expansion manager 1006 can include a prompt generator that can combine the relevant sentences with step-by-step generation instructions and, optionally, prompt/generation examples into a single prompt. This prompt is then provided to an LLM 1018 which generates generated text.

The multimodal content generation system 1000 also includes a text visualization manager 1008. The text visualization manager 1008 receives the generated text from the text expansion manager and determines whether the text is visual. For example, the text visualization manager 1008 can include a visual classifier, such as BERT classifier 1020, which predicts whether the generated text is visual. If it is not visual, then processing concludes, and the generated document is presented to the user. If the text is visual, then image data can either be retrieved from the reference documents or generated. In some embodiments, the text visualization manager 116 preferentially seeks to retrieve relevant images from the reference documents. In some embodiments, a CLIP model can be used to compare the generated text to images from the reference documents, as discussed above. If a matching image is found, then it is added to the generated document. If no matching image is found, then a new image can be generated. For example, a prompt generator may include a key-phrase extraction model which identifies key themes in the generated text. The prompt generator then combines the key themes into a one sentence prompt using an LLM. The prompt is then provided to the image generator, such as a diffusion model, which generates an image based on the prompt. Once the image is generated, it is added to the generated document and presented to the user.

As illustrated in FIG. 10, the multimodal content generation system 1000 also includes a neural network manager 1010. Neural network manager 1010 may host a plurality of neural networks or other machine learning models, such as CLIP model 1016, LLMs 1018, BERT classifier 1020, and encoder 1022. The neural network manager 1010 may include an execution environment, libraries, and/or any other data needed to execute the machine learning models. In some embodiments, the neural network manager 1010 may be associated with dedicated software and/or hardware resources to execute the machine learning models. Although depicted in FIG. 10 as being hosted by a single neural network manager 1010, in various embodiments the neural networks may be hosted in multiple neural network managers and/or as part of different components. For example, each model can be hosted by their own neural network manager, or other host environment, in which the respective neural networks execute, or the models may be spread across multiple neural network managers depending on, e.g., the resource requirements of each machine learning model, etc.

As illustrated in FIG. 10 the multimodal content generation system 1000 also includes training manager 1012. The training manager 1012 can teach, guide, tune, and/or train one or more neural networks. As described herein, the training manager 1012 can obtain training data automatically, by synthetically generating datasets using large document sources (e.g., Wikipedia corpus, or other public and/or private document sources). The training manager can use this training data 1024 to train and/or fine tune the models, as discussed above.

As illustrated in FIG. 10, the multimodal content generation system 1000 also includes the storage manager 1014. The storage manager 1014 maintains data for the multimodal content generation system 1000. The storage manager 1014 can maintain data of any type, size, or kind as necessary to perform the functions of the multimodal content generation system 1000. The storage manager 1014, as shown in FIG. 10, includes the training data 1024 and generated document 1026.

As described herein, the training manager 1012 obtains training data automatically and/or manually. The storage manager 1014 stores the training data 1024 such that the training manager 1012 can train, for example, the visual classifier (e.g., the BERT classifier) and the text expansion LLM(s) 1018. As described herein, training data 1024 can include a text expansion dataset that includes synthetically constructed context data, removed text, and guidelines which are used to train the text expansion LLMs to generate new text based on a text theme and relevant sentences. In some embodiments, the training data 1024 can include a visual classifier training dataset which includes positive and negative pairs of text data and image data. The positive pairs include text data that is strongly associated with the corresponding image data and the negative pairs include text data that is weakly associated with the corresponding image data.

The storage manager 1014 also stores generated document 1026. As described herein, the output of the multimodal content generation system is a generated document 1026. As discussed, this may represent a first draft of a document based on the text theme and reference documents provided by the user. The generated document can include the generated text content and image content, either retrieved or generated, as discussed.

Each of the components 1002-1014 of the multimodal content generation system 1000 may be in communication with one another using any suitable communication technologies. It will be recognized that although components 1002-1014 are shown to be separate in FIG. 10, any of components 1002-1014 may be combined into fewer components, such as into a single facility or module, divided into more components, or configured into different components as may serve a particular embodiment.

The components 1002-1014 can comprise software, hardware, or both. For example, the components 1002-1014 can comprise one or more instructions stored on a computer-readable storage medium and executable by processors of one or more computing devices. When executed by the one or more processors, the computer-executable instructions of the multimodal content generation system 1000 can cause a client device and/or a server device to perform the methods described herein. Alternatively, the components 1002-1014 can comprise hardware, such as a special purpose processing device to perform a certain function or group of functions. Additionally, the components 1002-1014 can comprise a combination of computer-executable instructions and hardware.

Furthermore, the components 1002-1014 of the multimodal content generation system 1000 may, for example, be implemented as one or more stand-alone applications, as one or more modules of an application, as one or more plug-ins, as one or more library functions or functions that may be called by other applications, and/or as a cloud-computing model. Thus, the components 1002-1014 of the multimodal content generation system 1000 may be implemented as a stand-alone application, such as a desktop or mobile application. Furthermore, the components 1002-1014 of the multimodal content generation system 1000 1000 may be implemented as one or more web-based applications hosted on a remote server. Alternatively, or additionally, the components of the multimodal content generation system 1000 may be implemented in a suite of mobile device applications or “apps.”

As shown, the multimodal content generation system 1000 can be implemented as a single system. In other embodiments, the multimodal content generation system 1000 can be implemented in whole, or in part, across multiple systems. For example, one or more functions of the multimodal content generation system 1000 can be performed by one or more servers, and one or more functions of the multimodal content generation system 1000 can be performed by one or more client devices. The one or more servers and/or one or more client devices may generate, store, receive, and transmit any type of data used by the multimodal content generation system 1000, as described herein.

In one implementation, the one or more client devices can include or implement at least a portion of the multimodal content generation system 1000. In other implementations, the one or more servers can include or implement at least a portion of the multimodal content generation system 1000. For instance, the multimodal content generation system 1000 can include an application running on the one or more servers or a portion of the multimodal content generation system 1000 can be downloaded from the one or more servers. Additionally or alternatively, the multimodal content generation system 1000 can include a web hosting application that allows the client device(s) to interact with content hosted at the one or more server(s).

For example, upon a client device accessing a webpage or other web application hosted at the one or more servers, in one or more embodiments, the one or more servers can provide access to a user interface displayed at a client device. The user interface can be used to upload a text including one or more words, one or more sentences, one or more paragraphs, one or more pages, and the like. The user interface can also display the uploaded text and a button (or other interactable object) that executes the text visualization system. Upon executing the text visualization system, the client device transmits the uploaded text to the one or more servers to perform the methods and processes described above. As a result, the one or more servers can provide, to the client device, one or more images corresponding to text identified as being visual text. The one or more servers can also update the text to include the one or more images (e.g., next to a paragraph including a sentence identified as being visual text, embedded, using a hyperlink, in a sentence identified as being visual text, etc.). The updated text and/or one or more images corresponding to text identified as being visual text is displayed to a user using the client device.

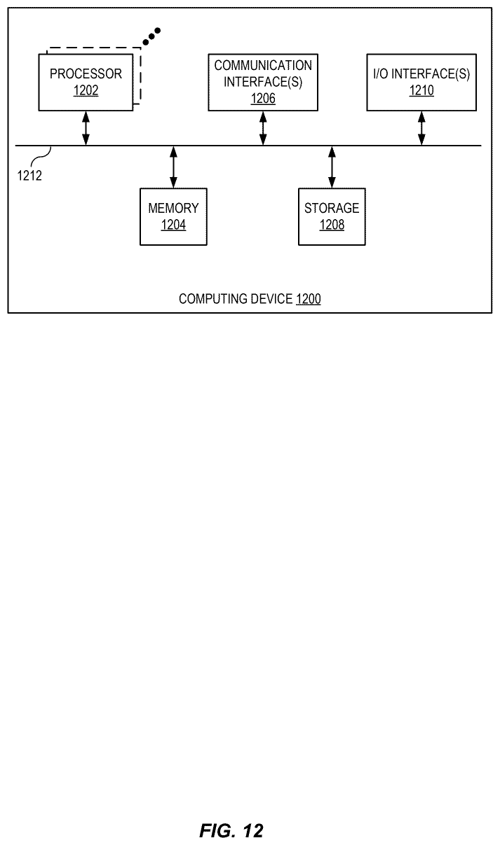

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 12. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 12.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 12.

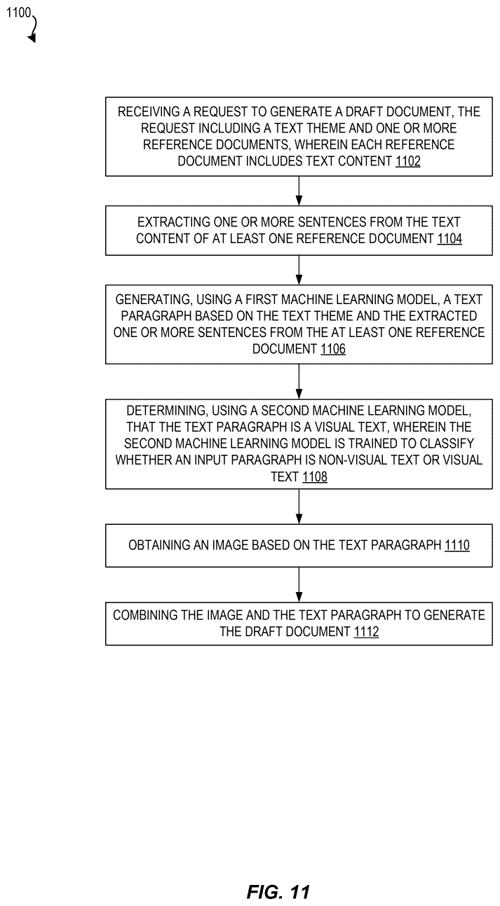

FIGS. 1-10, the corresponding text, and the examples, provide a number of different systems and devices that allow a user to generate a text augmented with images corresponding to visual text. In addition to the foregoing, embodiments can also be described in terms of flowcharts comprising acts and steps in a method for accomplishing a particular result. For example, FIG. 11 illustrates a flowchart of an exemplary method in accordance with one or more embodiments. The method described in relation to FIG. 11 may be performed with fewer or more steps/acts or the steps/acts may be performed in differing orders. Additionally, the steps/acts described herein may be repeated or performed in parallel with one another or in parallel with different instances of the same or similar steps/acts.

FIG. 11 illustrates a flowchart 1100 of a series of acts in a method of multimodal content generation, in accordance with one or more embodiments. In one or more embodiments, the method 1100 is performed in a digital medium environment that includes the multimodal content generation system 1000. The method 1100 is intended to be illustrative of one or more methods in accordance with the present disclosure and is not intended to limit potential embodiments. Alternative embodiments can include additional, fewer, or different steps than those articulated in FIG. 11.

As illustrated in FIG. 11, the method 1100 includes an act 1102 of receiving a request to generate a draft document, the request including a text theme and one or more reference documents, wherein each reference document includes text content. For example, the user may interact with the multimodal content generation system using a user interface of a document editing application or other application or system. The user may provide the reference documents and the text theme using the user interface (e.g., entering the text theme directly, providing links to the documents, etc.) and may request that the draft document be generated (e.g., by interacting with a graphical element of the user interface).

As illustrated in FIG. 11, the method 1100 includes an act 1104 of extracting one or more sentences from the text content of at least one reference document. In some embodiments, extracting one or more sentences from the text content of at least one reference document further includes encoding a plurality of paragraphs of the text content of the at least one reference document to obtain a plurality of paragraph embeddings and encoding the text theme to obtain a text theme embedding. At least one relevant paragraph from the plurality of paragraphs is then identified based on similarity values calculated based on the plurality of paragraph embeddings and the text theme embedding. In some embodiments, the at least one relevant paragraph is identified using an approximate nearest neighbors algorithm to identify the at least one relevant paragraph. In some embodiments, extracting the one or more sentences further includes extracting a plurality of sentences from the at least one relevant paragraph. The plurality of sentences is encoded to obtain a plurality of sentence embedding. Then the one or more sentences from the plurality of sentences are identified based on a similarity of the text theme embedding to the plurality of sentence embeddings.

As illustrated in FIG. 11, the method 1100 includes an act 1106 of generating, using a first machine learning model, a text paragraph based on the text theme and the extracted one or more sentences from the at least one reference document. In some embodiments, generating, using a first machine learning model, a text paragraph based on the text theme and the extracted one or more sentences from the at least one reference document, further includes creating a prompt for the first machine learning model using the one or more sentences and the text theme, wherein the prompt instructs the first machine learning model to generate the text paragraph using the one or more sentences and the text theme.

As illustrated in FIG. 11, the method 1100 includes an act 1108 of determining, using a second machine learning model, that the text paragraph is a visual text, wherein the second machine learning model is trained to classify whether an input paragraph is non-visual text or visual text. As discussed, the second machine learning model may be a visual classifier, such as a BERT classifier, that has been trained to determine if text content can be represented visually (e.g., visual text). When the text content is determined to be visual text then image content can be retrieved or generated to be added to the generated draft.

As illustrated in FIG. 11, the method 1100 includes an act 1110 of obtaining an image based on the text paragraph. In some embodiments, obtaining the image based on the text paragraph further includes extracting the image from a document of the one or more reference documents based on a similarity of the image to the text paragraph satisfying a threshold. In some embodiments, obtaining the image based on the text paragraph further includes extracting one or more key phrases from the text paragraph and creating a prompt for a diffusion machine learning model using the one or more key phrases, wherein the prompt instructs the diffusion machine learning model to generate the image using the one or more key phrases.

As illustrated in FIG. 11, the method 1100 includes an act 1112 of combining the image and the text paragraph to generate the draft document. In some embodiments, the generated document is then caused to be rendered in a user interface of a document editing application.

In some embodiments, the first machine learning model is a large language model trained using a synthetic training dataset that includes context data, removed text data, and guideline data constructed from a document corpus. In some embodiments, the second machine learning model is a BERT classifier trained using a synthetic training dataset that includes positive and negative pairs of training text and training images.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates, in block diagram form, an exemplary computing device 1200 that may be configured to perform one or more of the processes described above. One will appreciate that one or more computing devices such as the computing device 1200 may implement the text visualization system. As shown by FIG. 12, the computing device can comprise a processor 1202, memory 1204, one or more communication interfaces 1206, a storage device 1208, and one or more I/O devices/interfaces 1210. In certain embodiments, the computing device 1200 can include fewer or more components than those shown in FIG. 12. Components of computing device 1200 shown in FIG. 12 will now be described in additional detail.

In particular embodiments, processor(s) 1202 includes hardware for executing instructions, such as those making up a computer program. As an example, and not by way of limitation, to execute instructions, processor(s) 1202 may retrieve (or fetch) the instructions from an internal register, an internal cache, memory 1204, or a storage device 1208 and decode and execute them. In various embodiments, the processor(s) 1202 may include one or more central processing units (CPUs), graphics processing units (GPUs), field programmable gate arrays (FPGAs), systems on chip (SoC), or other processor(s) or combinations of processors.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1204 may be internal or distributed memory.

The computing device 1200 can further include one or more communication interfaces 1206. A communication interface 1206 can include hardware, software, or both. The communication interface 1206 can provide one or more interfaces for communication (such as, for example, packet-based communication) between the computing device and one or more other computing devices 1200 or one or more networks. As an example and not by way of limitation, communication interface 1206 may include a network interface controller (NIC) or network adapter for communicating with an Ethernet or other wire-based network or a wireless NIC (WNIC) or wireless adapter for communicating with a wireless network, such as a WI-FI. The computing device 1200 can further include a bus 1212. The bus 1212 can comprise hardware, software, or both that couples components of computing device 1200 to each other.

The computing device 1200 includes a storage device 1208 includes storage for storing data or instructions. As an example, and not by way of limitation, storage device 1208 can comprise a non-transitory storage medium described above. The storage device 1208 may include a hard disk drive (HDD), flash memory, a Universal Serial Bus (USB) drive or a combination these or other storage devices. The computing device 1200 also includes one or more input or output (“I/O”) devices/interfaces 1210, which are provided to allow a user to provide input to (such as user strokes), receive output from, and otherwise transfer data to and from the computing device 1200. These I/O devices/interfaces 1210 may include a mouse, keypad or a keyboard, a touch screen, camera, optical scanner, network interface, modem, other known I/O devices or a combination of such I/O devices/interfaces 1210. The touch screen may be activated with a stylus or a finger.

The I/O devices/interfaces 1210 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1210 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
receiving a request to generate a draft document, the request including a text theme and one or more reference documents, wherein each reference document includes text content;
extracting one or more sentences from the text content of at least one reference document;
generating, using a first machine learning model, a text paragraph based on the text theme and the extracted one or more sentences from the at least one reference document;
determining, using a second machine learning model, that the text paragraph is a visual text, wherein the second machine learning model is trained to classify whether an input paragraph is non-visual text or visual text;
obtaining an image based on the text paragraph; and
combining the image and the text paragraph to generate the draft document.

2. The method of claim 1, wherein extracting one or more sentences from the text content of at least one reference document further comprises:
encoding a plurality of paragraphs of the text content of the at least one reference document to obtain a plurality of paragraph embeddings;
encoding the text theme to obtain a text theme embedding; and
identifying at least one relevant paragraph from the plurality of paragraphs based on similarity values calculated based on the plurality of paragraph embeddings and the text theme embedding.

3. The method of claim 2, wherein identifying at least one relevant paragraph from the plurality of paragraphs based on similarity values calculated based on the plurality of paragraph embeddings and the text theme embedding, further comprises:
using an approximate nearest neighbors algorithm to identify the at least one relevant paragraph.

4. The method of claim 2, further comprising:
extracting a plurality of sentences from the at least one relevant paragraph;
encoding the plurality of sentences to obtain a plurality of sentence embeddings; and
identifying the one or more sentences from the plurality of sentences based on a similarity of the text theme embedding to the plurality of sentence embeddings.

5. The method of claim 1, wherein generating, using a first machine learning model, a text paragraph based on the text theme and the extracted one or more sentences from the at least one reference document, further comprises:
creating a prompt for the first machine learning model using the one or more sentences and the text theme, wherein the prompt instructs the first machine learning model to generate the text paragraph using the one or more sentences and the text theme.

6. The method of claim 1, wherein obtaining the image based on the text paragraph further comprises:
extracting the image from a document of the one or more reference documents based on a similarity of the image to the text paragraph satisfying a threshold.

7. The method of claim 1, wherein obtaining the image based on the text paragraph further comprises:
extracting one or more key phrases from the text paragraph; and
creating a prompt for a diffusion machine learning model using the one or more key phrases, wherein the prompt instructs the diffusion machine learning model to generate the image using the one or more key phrases.

8. The method of claim 1, further comprising:
causing the generated document to be rendered in a user interface of a document editing application.

9. The method of claim 1, wherein the first machine learning model is a large language model trained using a synthetic training dataset that includes context data, removed text data, and guideline data constructed from a document corpus.

10. The method of claim 1, wherein the second machine learning model is a BERT classifier trained using a synthetic training dataset that includes positive and negative pairs of training text and training images.

11. A non-transitory computer-readable medium storing executable instructions, which when executed by a processing device, cause the processing device to perform operations comprising:
receiving a request to generate a draft document, the request including a text theme and one or more reference documents, wherein each reference document includes text content;
extracting one or more sentences from the text content of at least one reference document;
generating, using a first machine learning model, a text paragraph based on the text theme and the extracted one or more sentences from the at least one reference document;
determining, using a second machine learning model, that the text paragraph is a visual text, wherein the second machine learning model is trained to classify whether an input paragraph is non-visual text or visual text;
obtaining an image based on the text paragraph; and
combining the image and the text paragraph to generate the draft document.

12. The non-transitory computer-readable medium of claim 11, wherein the operation of extracting one or more sentences from the text content of at least one reference document, further comprises:
encoding a plurality of paragraphs of the text content of the at least one reference document to obtain a plurality of paragraph embeddings;
encoding the text theme to obtain a text theme embedding; and
identifying at least one relevant paragraph from the plurality of paragraphs based on similarity values calculated based on the plurality of paragraph embeddings and the text theme embedding.

13. The non-transitory computer-readable medium of claim 12, wherein the operation of identifying at least one relevant paragraph from the plurality of paragraphs based on similarity values calculated based on the plurality of paragraph embeddings and the text theme embedding, further comprises:
using an approximate nearest neighbors algorithm to identify the at least one relevant paragraph.

14. The non-transitory computer-readable medium of claim 12, storing executable instructions that further cause the processing device to perform operations comprising:
extracting a plurality of sentences from the at least one relevant paragraph;
encoding the plurality of sentences to obtain a plurality of sentence embeddings; and
identifying the one or more sentences from the plurality of sentences based on a similarity of the text theme embedding to the plurality of sentence embeddings.

15. The non-transitory computer-readable medium of claim 11, wherein the operation of generating, using a first machine learning model, a text paragraph based on the text theme and the extracted one or more sentences from the at least one reference document, further comprises:
creating a prompt for the first machine learning model using the one or more sentences and the text theme, wherein the prompt instructs the first machine learning model to generate the text paragraph using the one or more sentences and the text theme.

16. The non-transitory computer-readable medium of claim 11, wherein the operation of obtaining the image based on the text paragraph further comprises:
extracting the image from a document of the one or more reference documents based on a similarity of the image to the text paragraph satisfying a threshold.

17. The non-transitory computer-readable medium of claim 11, wherein the operation of obtaining the image based on the text paragraph further comprises:
extracting one or more key phrases from the text paragraph; and
creating a prompt for a diffusion machine learning model using the one or more key phrases, wherein the prompt instructs the diffusion machine learning model to generate the image using the one or more key phrases.

18. A system comprising:
a memory component; and
a processing device coupled to the memory component, the processing device to perform operations comprising:
obtaining a digital document corpus comprising a plurality of digital documents, each digital document including at least text content;
identifying a plurality of portions of text in the text content that are relevant to a text expansion task;
generating, using a first machine learning model, a synthetic training dataset for the text expansion task based on the plurality of portions of the text, the synthetic training dataset including context data, removed text data, and guideline data; and
training a second machine learning model to perform the text expansion task using the synthetic training dataset.

19. The system of claim 18 wherein the operation of generating, using a first machine learning model, a synthetic training dataset for the training task based on the plurality of portions of the text, the synthetic training dataset including context data, removed text data, and guideline data, further comprises:
identifying a subset of the plurality of portions of text based at least one source quality and source accessibility;
extracting the context data and removed text data from each portion in the subset of the plurality of portions; and
generating the guideline data corresponding to each portion in the subset of the plurality of portions using a large language model based on corresponding removed text data.

20. The system of claim 18, wherein the trained second machine learning model is deployed as part of a multimodal content generation system to generate text content based on one or more reference documents and a text theme provided by a user.
